(19) United States
(12) Patent Application Publication
(10) Pub. No.: US 2024/0046718 A1
(43) Pub. Date: Feb. 8, 2024

(54) METHOD AND DEVICE FOR SAFELY PARKING A VEHICLE

(71) Applicant: MAN Truck & Bus SE, München (DE)

(72) Inventor: Gregor ADAMCZYK, München (DE)

(73) Assignee: MAN Truck & Bus SE, München (DE)

(21) Appl. No.: 18/268,968

(22) PCT Filed: Nov. 29, 2021
(86) PCT No.: PCT/EP2021/083304

§ 371 Date: Jun. 21, 2023

(30) Foreign Application Priority Data
Dec. 21, 2020 (DE) 10 2020 134 426.0

(51) Int. Cl. G07C 5/08

(52) U.S. Cl. CPC G07C 5/0816

(57) ABSTRACT

The invention relates to a method for safely parking a vehicle, wherein the vehicle comprises at least two vehicle axles, on each of which at least one axle load sensor is arranged. The method comprises the steps of: detecting the axle loads occurring on the at least two vehicle axles with the aid of the axle load sensors (S1); determining an axle load ratio for at least one of the vehicle axles on the basis of the detected axle loads (S2); and outputting a warning if the determined axle load ratio falls below a predetermined limit value (S3). As a result, it is possible—on the basis of the “on-board weighing system” usually present in commercial vehicles—to warn the driver of potentially critical parking positions, in particular on downhill slopes. The invention also relates to a corresponding warning device for carrying out this method and to a vehicle comprising such a warning device.

The invention relates to a method for safely parking a vehicle and to a corresponding warning device for carrying out this method. Furthermore, the invention relates to a vehicle with such a warning device.

Due to an increasing number of motor vehicles and the limited number of rest areas or man-aged parking facilities, drivers of commercial vehicles in particular are increasingly forced to use less suitable parking areas in order to comply with their allowable driving times. In particular, parking in sloping areas usually presents the driver with challenges when it comes to selecting a suitable parking position. Particularly in the case of less experienced or less trained drivers, who may have inadequate familiarity with the peculiarities and hazards of commercial vehicles, there is thus a risk that they may park the vehicle in a potentially dangerous parking position where, without further safety precautions, uncontrolled rolling or sliding of the vehicle may occur.

To protect the driver and other individuals, there is a need for a solution that may reliably avoid such hazardous situations. Specifically, there is a need for a solution that allows the vehicle to autonomously detect such situations and proactively alert the driver to the danger.

Accordingly, it is an objective of the invention to provide a solution for this requirement. In particular, it is the objective of the invention to provide a simple solution that enables secure parking of a vehicle on a slope, while minimizing the need for modifications to the vehicle itself.

These objectives may be achieved with the features of the independent claims. Advantageous embodiments and applications of the invention are the subject of the dependent claims and are further explained in the following description, with partial reference to the figures.

The basic idea behind the invention is to use the axle load sensors normally found in (commercial) vehicles and to use the axle load sensors to detect critical parking positions on slopes in order to provide the driver with an additional function that warns him of unsuitable or dangerous parking locations—without having to install additional sensors. The detection of critical parking positions is based on the fact that—as will be explained in more detail in connection with FIG. 4—the axle loads acting on the individual vehicle axles change as a function of the inclined position of the vehicle, since the vehicle's center of gravity is generally offset relative to the vehicle axles.

According to a first general aspect of the invention, a method for safely parking a vehicle (e.g., a semi-trailer truck) is provided for this purpose. Preferably, the method is a method for safely parking a vehicle on a slope. In this context, the vehicle is to comprise at least two vehicle axles, on each of which at least one axle load sensor is arranged. The term “vehicle axle” shall be understood according to the definition in the book B. Heifling (ed.) et al., “Fahrwerk-shandbuch” (in English: Chassis Manual) (Digital Object Identifier, DOI, 10.1007/978-3-8348-8168-7), Chapter 4, as the entire connection of two wheels and wheel suspension for individual wheels together with their connection to the chassis or chassis frame. Thus, according to the previous definition, a common passenger car usually has two axles.

The method comprises the step of detecting the axle loads occurring on the at least two vehicle axles with the aid of the axle load sensors. In accordance with common understanding, the term “axle load” is to be understood as the total load—usually specified in kilograms or tons—that is transmitted from the wheels of an axle to the roadway. In terms of measurement, the aforementioned “detection of axle loads” may also include a signal proportional to the actual “axle load” and/or a signal, e.g. electrical, from which the axle load may be derived.

Furthermore, the method comprises the step of determining an axle load ratio for at least one of the vehicle axles on the basis of the detected axle loads or on the basis of the detected signals. In this context, “axle load ratio” may be understood as the ratio of the axle load on the at least one vehicle axle to the sum of all detected axle loads. In the merely exemplary case of a vehicle with a front axle and a rear axle, the axle load ratio of the rear axle may thus be expressed, for example, using the formula G_{H}/(G+G_{VH}), where G_{V} describes the axle load of the front axle and G_{H} the axle load of the rear axle.

Finally, the method comprises the step of outputting (issuing) a warning if the determined axle load fraction falls below a predetermined, i.e. previously set, limit value. In other words, a warning may be outputted (issued) if the determined axle load ratio is less than a predetermined limit value. For this purpose, the method may comprise comparing the determined axle load ratio with the predetermined limit value, the limit value preferably being set in such a way that, if the axle load ratio exceeds this limit value, a sufficient braking effect may be achieved on the axle without the vehicle rolling or sliding away. In an advantageous manner, the driver may thus be warned of potentially critical parking positions, in particular on slopes, e.g. on the basis of the weighing system (“on-board weighing system”) that is usually already present in the (commercial) vehicle.

According to a first aspect of the invention, the aforementioned warning may indicate that safe parking of the vehicle is not possible. In addition or alternatively, the warning may also indicate that a different parking position should be adopted and/or that the vehicle should be additionally secured, for example by means of wheel chocks. The warning may be an optical and/or acoustic and/or tactile warning. By way of example only, a warning symbol or indicator lamp may light up on a vehicle instrument panel and/or a warning tone may be emitted if the determined axle load ratio falls below the predetermined limit value.

According to a further aspect of the invention, the method may be performed only when or, preferably immediately, after a vehicle is parked. In other words, the method is to be carried out only if parking of the vehicle is currently taking place or, preferably, has just been parked. In an advantageous manner, undesired false warnings, for example, when briefly driving through a steep section of a road and/or during momentary dynamic changes in axle load (e.g., due to rolling) while driving, may thereby be efficiently avoided.

In order to detect a corresponding parking of the vehicle as effectively as possible, the method may further comprise a detection of at least one signal which indicates a parking of the vehicle. By way of example only, the at least one signal may be emitted when the engine is turned off, when the ignition key is removed, when the parking brake is engaged, when the driver's door is opened, and/or when the driver's seat is empty. For this purpose, the vehicle may comprise corresponding signal and/or sensor devices for generating the aforementioned signals. As a rule, however, such devices are already installed as standard in the vehicle and are used, for example, in connection with further assistance systems, such as a “lights on” warning buzzer when the vehicle is parked. Accordingly, these devices may often be used without requiring significant retrofitting efforts within the scope of the method of the invention. Depending on the detected at least one signal, the further steps of the method may then be carried out. Preferably, the further steps (detecting the axle loads, determining the axle load ratio and issuing the warning) are only carried out if the detected at least one signal indicates that the vehicle is being parked or has been parked.

According to a further aspect of the invention, the axle load ratio may indicate the ratio of the axle load on the at least one vehicle axle to the sum of the axle loads on the at least two vehicle axles. In other words, the axle load ratio may be understood to be the ratio of the axle load on the at least one vehicle axle to the sum of the detected axle loads. In the exemplary case of a vehicle with a front axle and a rear axle, the axle load ratio of the rear axle may thus be expressed, for example, using the formula G_{H}/(G+G_{VH}), where G_{V} describes the axle load of the front axle and G_{H} describes the axle load of the rear axle. The inventor has found that this quantity, which may be easily derived, for example, on the basis of the on-board weighing system usually present in the vehicle, may be used advantageously and is particularly effectively for detecting possibly unsuitable or dangerous parking positions on downhill slopes.

According to a further aspect of the invention, the predetermined limit value may be a limit value dependent on a vehicle model. Since different vehicle models generally differ in design or vehicle geometry (wheelbase, axle formula, etc.), it may be advantageous to set a corresponding limit value for each vehicle model. Accordingly, the method may comprise setting the predetermined limit value as a function of a vehicle model or as a function of the vehicle model of the vehicle. This may be done, for example, by means of corresponding parking tests on slopes with a known gradient.

In addition or alternatively, the predetermined limit value may be a limit value independent of a current loading state of the vehicle. I.e., the predetermined limit value may be the same for a vehicle with a full tank and loaded with a driver and his luggage as for an empty vehicle with an approximately empty tank. Advantageously, this provides the simplest possible means of detecting critical parking positions on slopes.

According to a further aspect of the invention, the method may comprise a determination of the predetermined limit value taking into account parking tests on slopes of known gradient. For example, the vehicle may be parked for this purpose on a test stand whose slope is grad-ually increased, starting from a horizontal position, until the vehicle starts to slide, i.e. the force resulting from the slope down exceeds the braking effect of the vehicle. On the basis of the axle load components occurring at this limit slope, a corresponding limit value may then be defined for this vehicle or this vehicle model, preferably taking into account certain safety and/or tolerance margins (allowances).

According to a further aspect of the invention, the parking tests may be performed with the vehicle loaded as lightly as possible, preferably with no load, and/or with the tank capacity as low as possible, preferably with an empty tank. I.e., in other words, the limit may be performed for the lightest possible vehicle, i.e., a vehicle without a driver and with a nearly empty tank.

This is advantageous because the additional weight increases the weight force and thus the static friction force, which generally reduces the risk of the vehicle rolling or sliding away.

According to a further aspect of the invention, the method may comprise a determination of the predetermined limit value taking into account parking tests on different floor surfaces. Preferably, different weather conditions of the floor surfaces (e.g. a wet road surface) and/or different loading conditions of the vehicle are also taken into account.

According to a further aspect of the invention, the at least one vehicle axle for which a determination of the axle load ratio is performed may comprise a parking brake device. The parking brake device, which may also be referred to as a brake lock, may thereby comprise a spring-loaded brake cylinder, wherein the parking brake device may be engaged by venting the spring-loaded brake cylinder and released by venting the spring-loaded brake cylinder. In addition or alternatively, the at least one vehicle axle for which a determination of the axle load ratio is performed may be a rear axle of the vehicle.

According to another aspect of the invention, the at least one axle load sensor may comprise a strain gauge and/or a displacement sensor. In addition or alternatively, however, other meth-ods known in the prior art for axle load sensing, such as piezorestrictive quartz force transduc-ers, may be used. Furthermore, the at least two vehicle axles may also be air-sprung vehicle axles, whereby the axle load sensing may then also be carried out via pressure sensors connected to or arranged on spring bellows of the air springs.

Furthermore, it should be mentioned in this context that, for the sake of clarity, the description primarily focuses on a vehicle with individual vehicle axles. However, as readily apparent to those skilled in the art, the teachings can easily be applied to axle groups, such as tandem axles or dual axle assemblies, without departing from the scope of the invention. In other words, a “vehicle axle” mentioned in this document can also refer to an axle group, such as a dual (double) axle.

According to another independent aspect, a warning device for a vehicle is provided, wherein the warning device is configured to perform a method as described in this document. For this purpose, the warning device may comprise a processor and a memory. Preferably, the memory includes instructions executable by the processor for this purpose, whereby the warning device as a whole is capable of performing a previously described method. Furthermore, the warning device may be in communication with corresponding axle load sensors, for example via signal lines, and/or include the corresponding axle load sensors as part of the warning device. In this way, a device for warning the driver of potentially critical parking positions, in particular on slopes, may be provided in an advantageous manner.

Furthermore, the invention relates to a vehicle comprising at least two vehicle axles, e.g. a front axle and a rear axle, on each of which at least one axle load sensor is arranged. Further, the vehicle comprises a warning device as described herein. Here, too, the warning device may be connected to the axle load sensors via corresponding signal lines.

According to another aspect of the invention, the vehicle may be a commercial vehicle. In other words, the vehicle may be a vehicle designed by its construction and equipment to carry pas-sengers, to carry goods, or to tow trailer vehicles. By way of example only, the vehicle may be a semitrailer truck without a semitrailer coupled thereto.

The aspects and features of the invention described above may be combined in any desired manner. Further details and advantages of the invention are described below with reference to the accompanying drawings.

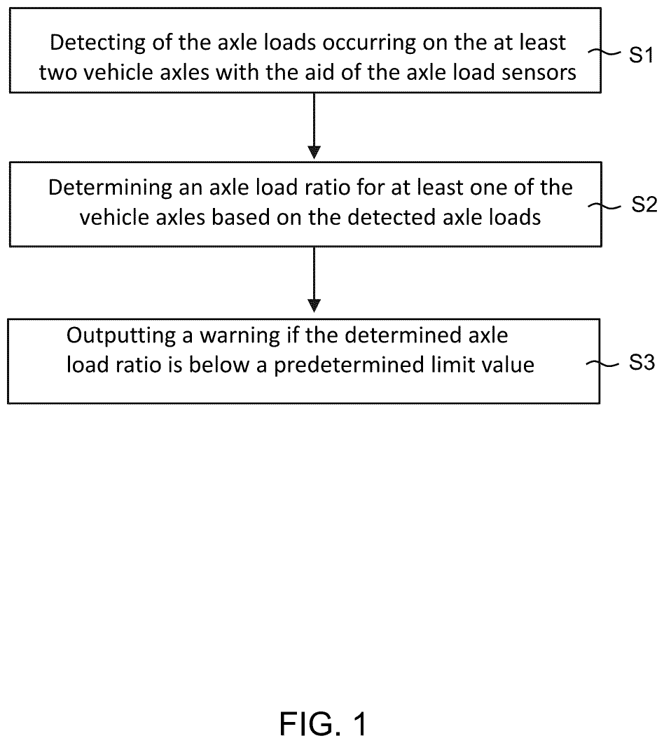

FIG. 1 shows a schematic flow diagram of a method for safely parking a vehicle according to an embodiment of the invention;

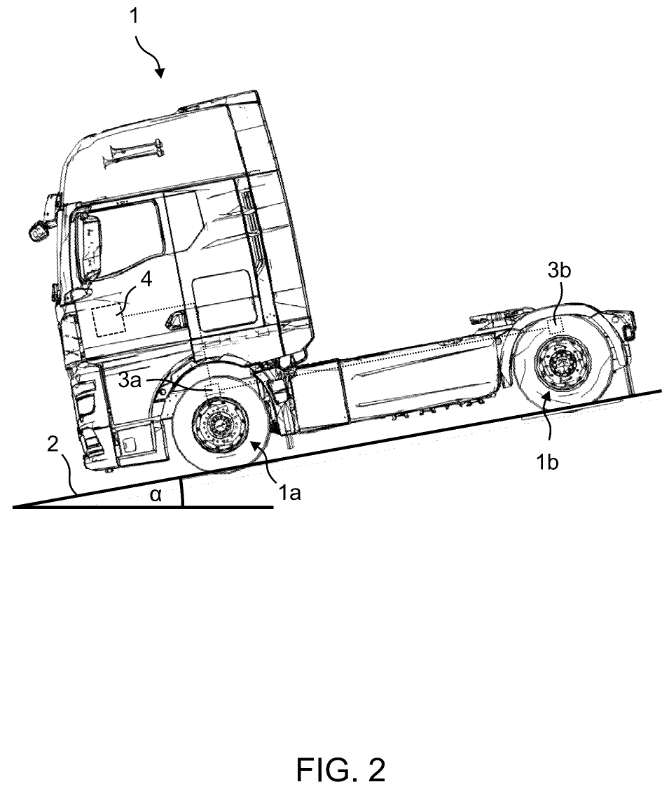

FIG. 2 shows a schematic representation of a vehicle comprising a warning device according to an embodiment of the invention; and

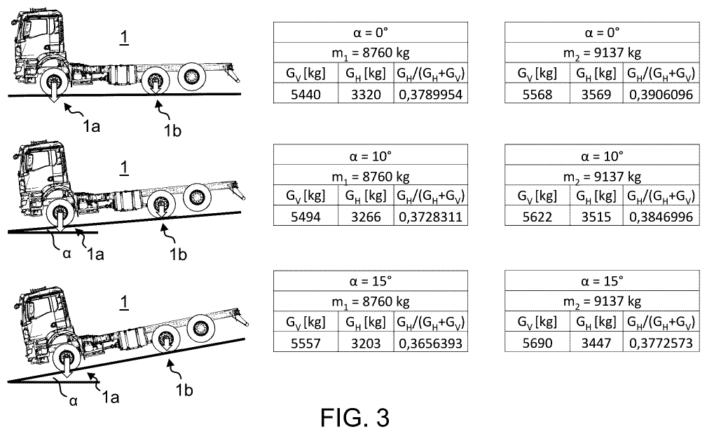

FIG. 3 shows exemplary axle load distributions for a vehicle with two vehicle axles for different angles of inclination and different loading conditions.

Identical or functionally equivalent elements are designated with the same reference signs in all figures and are not described separately in some cases.

FIG. 1 shows a schematic flow diagram of a method for safely parking a vehicle 1 according to one embodiment of the invention. The vehicle 1 is to comprise at least two vehicle axles, for example a front axle 1a and a rear axle 1b, on each of which at least one axle load sensor 3a, 3b is arranged. In step S1, the axle loads occurring on the at least two vehicle axles 1a, 1b are detected with the aid of the axle load sensors 3a, 3b. In the merely exemplary case of two vehicle axles—i.e. a front axle 1a and a rear axle 1b—the axle load G_{V} occurring on the front axle 1a and the axle load G_{H} occurring on the rear axle 1b may thus be detected in step S1.

In step S2, an axle load ratio is then determined for at least one of the vehicle axles on the basis of the detected axle loads. In the above-mentioned example, the may axle load ratio of the rear axle 1b may be determined in step S2 according to the formula G_{H}/(G+G_{VH}). In addition or alternatively, however, the may axle load ratio of the front axle 1a could also be determined according to the formula G_{V}/(G+G_{VH}). Preferably, in step S2 the axle load ratio is determined for a vehicle axle that includes a parking brake device, which is usually the rear axle 1b.

In step S3, a warning is then outputted if the determined axle load fraction falls below a predetermined, i.e. previously defined, limit value. In other words, the method may comprise comparing the determined axle load ratio with a predetermined limit value, whereby a warning may be outputted (issued) if the determined axle load ratio is less than the predetermined limit value, and preferably no warning is outputted (issued) if the determined axle load ratio is equal to or greater than the predetermined limit value.

FIG. 2 shows a schematic representation of a vehicle 1, comprising a warning device 4 according to one embodiment of the invention. In the present case, the vehicle 1 is—by way of example only—a semitrailer truck (a tractor unit) without a corresponding semitrailer. The semitrailer truck is located on a slope 2 which is inclined by an angle α with respect to the horizontal, i.e. rises in the opposite direction to the direction of travel of the vehicle 1 with a gradient S=tan(a).

Furthermore, the vehicle 1 comprises at least two vehicle axles, in this case a front axle 1a and a rear axle 1b, on each of which at least one axle load sensor 3a, 3b is arranged. In the present example, the axle load sensor 3a is arranged on the front axle 1a and the axle load sensor 3b is arranged on the rear axle 1b, whereby the respective vehicle axles 1a and 1b may additionally comprise further axle load sensors, for example for detecting lateral axle load distributions.

According to the invention, the vehicle 1 further comprises a warning device 4 which is designed to carry out a method as described in this document. For this purpose, the warning device 4 may be in communication with the aforementioned axle load sensors 3a and 3b via corresponding signal lines, shown in dashed lines in FIG. 2, in order to receive the axle loads detected by the axle load sensors 3a and 3b. On the basis of these axle loads, the warning device 4 may then determine an axle load ratio for at least one of the vehicle axles, e.g. the rear axle 1b, and issue a warning if the axle load ratio determined falls below a predetermined limit value, the limit value preferably being set in such a way that, if the axle load ratio exceeds this limit value, sufficient braking action may be achieved on the corresponding vehicle axle when the vehicle 1 is parked without the vehicle 1 rolling or sliding away.

FIG. 3 shows exemplary axle load distributions for a vehicle 1 with two vehicle axles—a front axle 1a and a rear axle 1b—for different angles of inclination α and different loading conditions (m₁ and m₂). In this case, vehicle 1 is again a semitrailer truck without a semitrailer—as already discussed in connection with FIG. 2, and therefore, detailed referencing of all corresponding vehicle components has been omitted here.

In the case shown at the top of FIG. 3, the vehicle 1 is on a level roadway that has no incline or slope (S=0). In contrast, the case shown in the middle of FIG. 3 shows a situation in which the vehicle 1 is on a slope 2 that is inclined by α=10° with respect to the horizontal, i.e. slopes down in the direction of travel of the vehicle tractor 1 with a gradient S of approximately 18%. In the case shown at the bottom of FIG. 3, the semitrailer truck is located on an even more steeply inclined roadway, which is inclined by α=15° with respect to the horizontal, i.e. slopes down in the direction of travel of the vehicle train 1 with a gradient S of approximately 27%.

The values provided in the respective tables represent exemplary axle load distributions in the various inclination situations. The left column corresponds to the case of an almost empty vehicle 1 (without driver and without fuel) with a total weight of 8760 kg, while the right column pertains to the case of a vehicle 1 with a driver (75 kg) and a full tank, resulting in a corresponding total weight of 9137 kg.

As may be seen from the horizontal case (shown at the top), the axle load in this case is front-loaded due to the design-related component distribution, i.e. the center of gravity is closer to the front axle 1a than to the rear axle 1b, resulting in a greater axle load G_{V} on the front axle 1a than on the rear axle 1b (G_{H}<G_{V}). As the gradient (center and bottom) increases, the direction of action of the center of gravity moves, which means that the front axle 1a is loaded more and the rear axle 1b is relieved more, which is then also reflected in the axle load ratio of the rear axle 1b, i.e. in the value G_{H}/(G+G_{VH}). This drops—for the empty vehicle 1—from a value of 0.3789954 in the horizontal case to 0.3656393 at an angle of inclination of 15°. This trend may also be observed in the case of the loaded vehicle 1, although the overall larger axle loads G_{V}, G_{H} result in somewhat larger axle load shares.

Above a certain angle of inclination α_{grenz}, the static friction of the rear axle 1b—in the case of a parking brake usually fitted to the rear axle 1b—would no longer be sufficient to hold the vehicle 1 on the incline 2, so that there would then be a risk of uncontrolled rolling away or sliding of the vehicle 1 without further safety measures. This is where the solution according to the invention comes into play, which warns the driver of such critical situations by issuing a warning if the axle load fraction (in this case, the rear axle 1b) falls below a predetermined threshold. This is where the solution according to the invention comes in, which warns the driver of such critical situations by issuing a warning if the axle load component (here of the rear axle 1b) falls below a predetermined limit value. As illustrated by the two exemplary cases with m₁ and m₂, the danger is greater in the case of a light, i.e. lightly loaded, vehicle 1, since less weight is loaded on the axles, so that the limit value is preferably set in such a way that sufficient braking effect may still be achieved on the axle even with the lightest possible vehicle.

Although the invention has been described with reference to specific embodiments, it is apparent to one skilled in the art that various modifications may be made and equivalents may be used as substitutes without departing from the scope of the invention. Consequently, the invention is not intended to be limited to the disclosed embodiments, but is intended to encom-pass all embodiments that fall within the scope of the enclosed claims. In particular, the invention also claims protection for the subject matter and features of the dependent claims independent of the claims referenced.

### LIST OF REFERENCE SIGNS

1 vehicle
1a, 1b vehicle axle
2 slope
3a, 3b axis load sensor
4 warning device

1-13. (canceled)

14. A method for safely parking a vehicle, the vehicle comprising at least two vehicle axles, on each of which at least one axle load sensor is arranged, the method comprising the steps:
detecting of the axle loads occurring on the at least two vehicle axles with the aid of the axle load sensors;
determining an axle load ratio for at least one of the vehicle axles based on the detected axle loads; and
outputting a warning if the determined axle load ratio is below a predetermined limit value.

15. The method according to claim 14, wherein the method is for safely parking a vehicle on a slope.

16. The method according to claim 14, wherein the warning indicates that safe parking of the vehicle is not possible and/or another parking position should be taken and/or the vehicle should be additionally secured.

17. The method according to claim 14, wherein the method is carried out only when after the vehicle is parked.

18. The method according to claim 14, wherein the method is carried out only immediately after the vehicle is parked.

19. The method according to claim 17, wherein by detecting at least one signal indicating that the vehicle has been parked, and wherein the further steps of the method being carried out as a function of the detected at least one signal.

20. The method according to claim 19, wherein the signal is outputted when the engine is switched off and/or when the ignition key is removed.

21. The method according to claim 14, wherein the axle load ratio indicates the ratio of the axle load on the at least one vehicle axle to the sum of the axle loads on the at least two vehicle axles.

22. The method according to claim 14, wherein the predetermined limit value
a) is a limit value dependent on a vehicle model; and/or
b) is a limit value that is independent of a current loading condition of the vehicle.

23. The method according to claim 14, wherein the at least one axle load sensor comprises a strain gauge and/or a displacement sensor.

24. The method according to claim 14, wherein the at least one vehicle axle for which a determination of the axle load ratio takes place,
a) comprises a parking brake device; and/or
b) is a rear axle of the vehicle.

25. The method according to claim 14, wherein determining of the predetermined limit value taking into account parking tests on slopes with known gradient.

26. The method according to claim 25, wherein the parking tests are carried out with the lowest possible load and/or the lowest possible tank content of the vehicle.

27. The method according to claim 26, wherein the lowest possible load is no load and/or the lowest possible tank contest is an empty tank.

28. A warning device for a vehicle, wherein the warning device is configured to perform a method according to claim 14.

29. A vehicle comprising at least two vehicle axles, on each of which at least one axle load sensor is arranged, and a warning device according to claim 28.

30. The vehicle according to claim 29, wherein the vehicle is a commercial vehicle.

31. The vehicle according to claim 30, wherein the commercial vehicle is a semitrailer truck.
